(19) United States
(12) Patent Application Publication
(10) Pub. No.: US 2025/0121305 A1
(43) Pub. Date: Apr. 17, 2025

(54) VISUAL REMINDER SYSTEM FOR A FILTER ELEMENT

(71) Applicant: SAFRAN HELICOPTER ENGINES, BORDES (FR)

(72) Inventors: Nicolas Christophe PERRA, MOISSY CRAMAYEL (FR); Mathieu Pierre CLADIERE, MOISSY CRAMAYEL (FR)

(21) Appl. No.: 18/834,749

(22) PCT Filed: Jan. 20, 2023
(86) PCT No.: PCT/FR2023/050085

§ 371 Date: Jul. 31, 2024

(30) Foreign Application Priority Data
Feb. 1, 2022 (FR) 2200869

(51) Int. Cl. B01D 35/143

(52) U.S. Cl. CPC B01D 35/143; B01D 2201/16; B01D 2201/4069

(57) ABSTRACT

A filtering device for a turbomachine, includes a filter support; a removable filter cooperating with the filter support; a cover; an indicator pin; a plate that is translatably movable relative to the cover and relative to the indicator pin, the plate being translatably movable between two positions: a first position such that the plate bears against the removable filter and the indicator pin is in a retracted position, a second position such that the plate is remote from the cover due to the absence of the removable filter and the indicator pin is in an extended position.

### TECHNICAL FIELD OF THE INVENTION

The technical field of the invention is that of the oil and fuel circuits of turbomachines.

The present invention relates to a filtering device. The invention also relates to a method for indicating presence of a filter, as well as to a turbomachine.

### TECHNOLOGICAL BACKGROUND OF THE INVENTION

Conventionally, turbomachines include oil and fuel circuits in which filtering elements (or filters) are used to protect downstream elements in the circuits. The filtering systems for these circuits generally include a filter support which cooperates with a removable filter (or filter cartridge).

FIG. 1 is an exploded view of a filtering device according to prior art including a cylindrical shaped filter 1 and including an axis A. FIG. 2 is a cross-sectional view along axis A of the filter 1 of the filtering device according to prior art. A filter support 2 cooperates with the filter 1 via a cylindrical rod 29 integral with the filter support 2 inserted in a hollow cylindrical part 19 of the filter 1. A clogging valve 17 is translationally movable relative to the filter support 2 via a spring. A cylindrical shaped cup 3 is inserted into the hollow part 19 for holding the filter 1 in position.

It sometimes happens that the filtering device is mounted even though no filter has been disposed in said device. Operating the turbomachine without a filtering element can lead to engine malfunctions.

Solutions are known to prevent the turbomachine from being put into service without a filter.

For example, screwing a drain plug onto a filter is a known solution. The drain plug cannot be screwed on if the filter is missing. If the drain plug is not screwed on, a major oil or fuel leak will quickly be detected. However, this solution only allows the leak to be detected upon putting the turbomachine into service.

Another solution is to design two holes on the bottom of the filter housing in order to cause leak in the absence of a filter. The filter includes two O-rings present on the internal and external diameters of the filter to ensure sealing with the filter support. However, this solution only allows the leak to be detected upon putting the turbomachine into service.

Thus, existing solutions do not, without drawbacks, provide a reliable mechanical guarantee of filter mounting in a filtering system.

### SUMMARY OF THE INVENTION

The invention offers a solution to the problems discussed previously, by making it possible to detect absence of a filter in a filtering device, especially for a turbomachine before said turbomachine is put into service.

A first aspect of the invention relates to a filtering device comprising:
a filter support;
a removable filter cooperating with the filter support;
a cover translationally movable relative to the filter support;
a clogging valve translationally movable relative to the filter support and connected to one end of the filter support via a first compression spring with a first compression force F1;
a magnet positioned at one end of the clogging valve;
an indicator pin having a magnetic surface, being translationally movable relative to the cover and connected to the cover via a second compression spring with a second compression force F2, the magnetic surface facing the magnet, the indicator pin being translationally movable between two positions:
   an extended position such that the indicator pin projects from a surface of the cover;
   a retracted position such that the indicator pin is in contact with the magnet;
      the device comprises a plate integral with the clogging valve, the plate being translationally movable relative to the cover and relative to the indicator pin via third compression springs positioned between the plate and the cover, the third compression springs having a third compression force F3 greater than the first compression force F1 of the first compression spring, the plate being translationally movable between two positions:
a first position such that the plate bears against the removable filter and the indicator pin is in the retracted position;
a second position such that the plate is remote from the cover due to the absence of the removable filter and the indicator pin is in the extended position.

Thus, the indicator pin is projecting and is therefore visible if the removable filter is not mounted to the device. This makes it possible to indicate absence of the filter and to enable absence of the removable filter to be detected before the turbomachine is started up via a visual indicator which is the indicator pin. The third compression springs hold the plate in the second position in the absence of the removable filter.

Advantageously, the plate comprises a first cylindrical surface cooperating with a second cylindrical surface of the filter support. Thus, the filter support makes it possible to guide the plate along the axis of the filter support.

Advantageously, the plate comprises a first planar surface in contact with a first circumferential surface of the filter support when the plate is in the second position. The first circumferential surface acts as a stop for the plate when the latter is in the second position.

Advantageously, the third compression springs are each in contact with the cover and with a second circumferential surface of the plate. The third compression springs hold the plate in the second position when the removable filter is absent from the device.

Advantageously, the third compression springs are positioned in cover housings located in the cover. The cover housings hold the third compression springs facing the plate.

A second aspect of the invention relates to a method for indicating presence of a filter in said device comprising:
a step of mounting the cover;
a step of pressing on the indicator pin translating the indicator pin from the extended position to the retracted position;
if the removable filter is mounted to the device, then the indicator pin is held in the retracted position;
if the removable filter is absent from the device, then the indicator pin translates from the retracted position to the extended position.

A third aspect of the invention relates to a turbomachine including said filtering device.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 is an exploded view of a filtering device according to prior art.

FIG. 2 is a cross-sectional view of the filtering device according to prior art.

FIG. 3 is an exploded view of a filtering device according to the invention without a removable filter.

FIG. 4 is a perspective view of the filtering device according to the invention without a removable filter.

FIG. 5 is a cross-section view along an axis B of the filtering device according to the invention without a removable filter.

FIG. 6 is an enlarged view of FIG. 5.

FIG. 7 is a cross-sectional view along axis B of the filtering device according to the invention.

FIG. 8 is an enlarged view of FIG. 7.

FIG. 9 is an exploded view of a cover and a plate of the filtering device according to the invention.

FIG. 10 is a cross-sectional and perspective view of a clogging valve of the filtering device according to the invention.

FIG. 11 is a functional diagram of the filtering device according to the invention in the absence of a removable filter.

FIG. 12 is a functional diagram of the filtering device according to the invention.

FIG. 13 is a block diagram of a method for indicating presence of a filter in a device according to the invention.

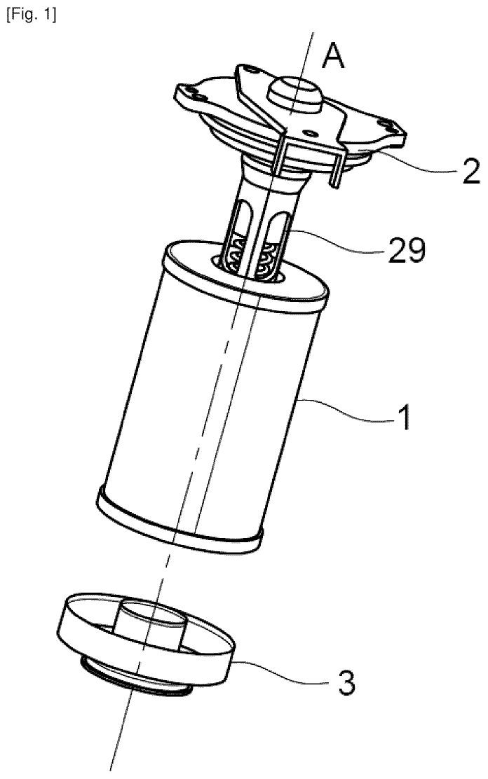

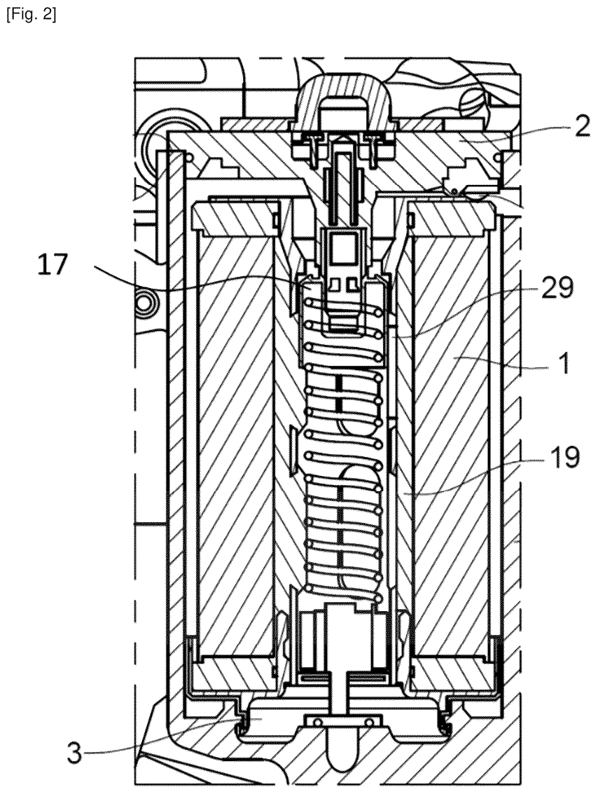

### DETAILED DESCRIPTION

Unless otherwise specified, a same element appearing in different figures has a single reference.

An example of a filtering device according to the invention comprises a filter support and a clogging valve connected to the filter support by a first compression spring. The device further comprises a cover comprising an indicator pin translating in the cover and connected thereto through a second compression spring.

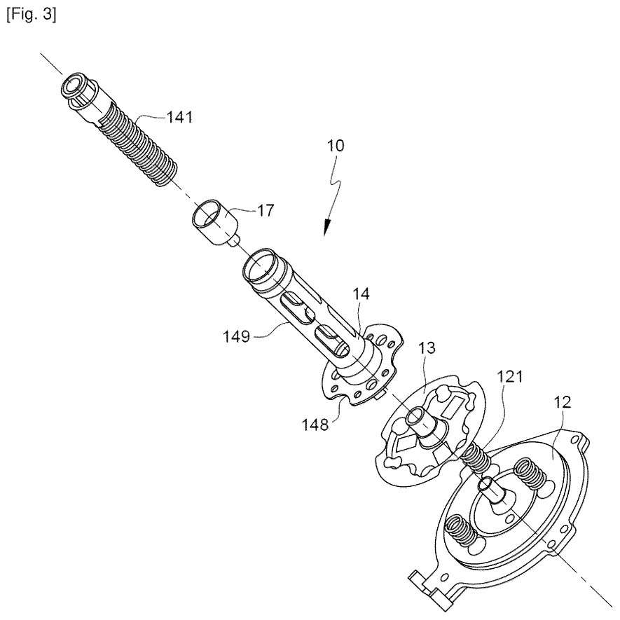

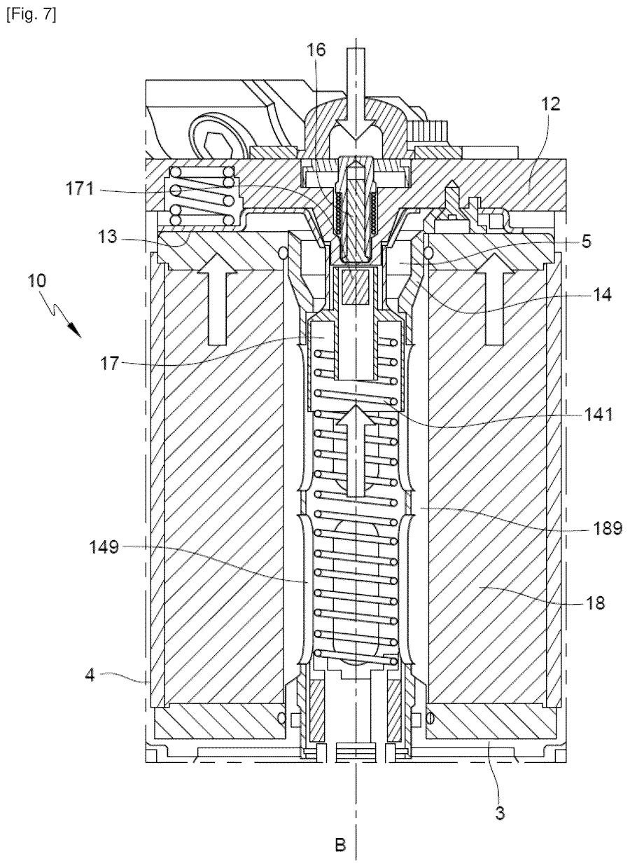

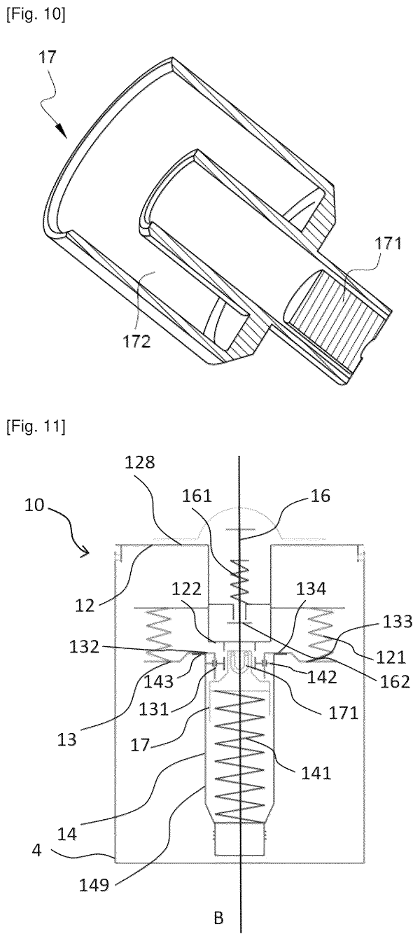

FIGS. 3 to 6 and 11 represent the filtering device 10 according to the invention without a removable filter. FIGS. 7, 8 and 12 represent the filtering device 10 according to the invention with the removable filter 18.

FIG. 3 is an exploded view of the filtering device 10 including:
the cover 12,
an overall circular plate 13,
three third compression springs 121 positioned between the cover 12 and the plate 13 and in contact with the cover 12 and the plate 13,
the filter support 14 cooperating with the plate 13 and comprising
   a first hollow cylinder 149 and
   a platform 148 attached to one end of the first hollow cylinder 149;
the cylindrical shaped clogging valve 17
the first compression spring 141 connecting the clogging valve 17 to the filter support 14.

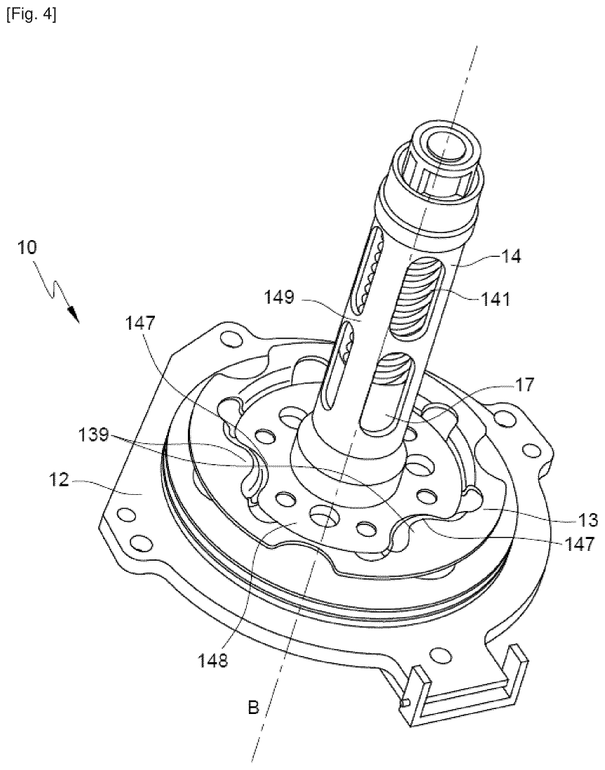

FIG. 4 is a perspective view of the filtering device 10. The clogging valve 17 is mounted in the first hollow cylinder 149. The clogging valve 17 is translationally movable relative to the filter support 14 such that the clogging valve 17 can translate in the first hollow cylinder 149 along an axis B of the first hollow cylinder 149. The first compression spring 141 is mounted in the first hollow cylinder 149 and is in contact with the clogging valve 17. The first compression spring 141 holds the clogging valve 17 at one end of the first hollow cylinder 149.

The plate 13 and the platform 148 of the filter support 14 cooperate and fit together such that there is no possible rotational movement between the plate 13 and the platform 148 along the axis B. Indeed, the plate 13 comprises protrusions 139 cooperating with recesses 147 of the platform 148 located on the periphery of the platform 148. For example, the plate 13 comprises three protrusions 139 cooperating 30 with three recesses 147 in the platform 148. The protrusions 139 block rotation of the filter support 14 about the axis B.

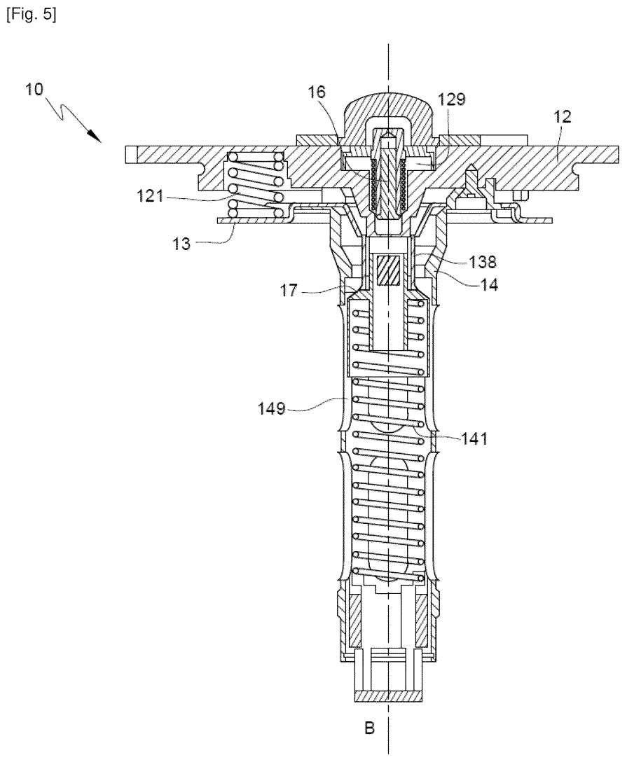

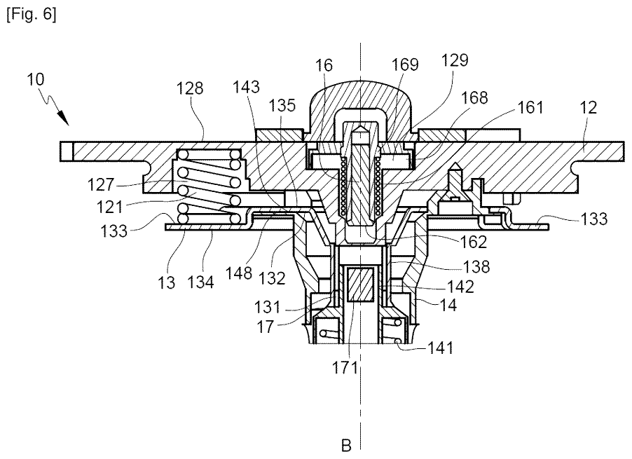

As represented in FIG. 5 and FIG. 6, the platform 13 comprises a second hollow cylinder 138 including an axis coaxial with axis B.

The clogging valve 17 is translationally movable along the axis B with respect to the plate 13. The clogging valve 17 comprises a magnet 171 located at one of its ends. The clogging valve 17 is cylindrical in shape and the cylindrical shaped magnet 171 is positioned in the second hollow cylinder 138 of the plate 13.

As regards the elements in the cover 12, the indicator pin 16 is mounted in a cylindrical cavity 129 in the cover 12. Indicator pin 16 is cylindrical in shape and has an axis coaxial with axis B. The indicator pin 16 is translationally movable relative to the cover 12. The second compression spring 161 is positioned around the indicator pin 16 and inside the cavity 129 and exerts a second compression force F2 along the axis B towards a direction opposite to the clogging valve 17.

The indicator pin 16 comprises a magnetic surface 162 facing the magnet 171 of the clogging valve 17. The magnet 171 exerts an attractive electromagnetic force on the magnetic surface 162 of the indicator pin 16 such that the indicator pin 16 is attracted towards the magnet 171. The electromagnetic force of the magnet 171 is of a direction opposite to the second compression force F2 of the second compression spring 161. The indicator pin 16 also comprises a shoulder 169 which acts as a stop and prevents the indicator pin 16 from leaving the cavity 129 of the cover 12. The shoulder 169 is on the stop on a stop surface 168 of the cover 12.

Thus, the indicator pin 16 is translationally movable along the axis B between two positions:
An extended position (represented in FIGS. 5, 6 and 11) such that the indicator pin 16 projects from a surface of the cover 128.
A retracted position (represented in FIGS. 7, 8 and 12) such that the magnetic surface 162 is in contact with the magnet 171. In the retracted position, the indicator pin 16 does not project from the surface of the cover 128.

When the indicator pin 16 is in the extended position, the shoulder 129 is on the stop on the stop surface 168 of the cover 12.

As represented in FIG. 6, the plate 13 comprises a first planar surface 132 in contact with a first circumferential surface 143 of the platform 148.

As represented in FIG. 6, the third compression springs 121 are positioned between the plate 13 and the cover 12 to exert a third compression force F3 thereon. In the example under consideration, the device 10 comprises three third compression springs 121 (only one of the third compression springs 121 is represented in the cross-section view of FIG. 6) distributed around the periphery of the plate 13. There could be more or less than three third compression springs 121 without departing from the scope of the present invention. Each third compression spring 121 is in contact with a second circumferential surface 133 of the plate 13 located close to the radial edges of the plate 13 with respect to the axis B. The second circumferential surface 133 is parallel to the first planar surface 132 but is not in the same plane as the first planar surface 132. The third compression springs 121 are also in contact with the cover 12 and each positioned in a respective cover housing 127. The cover 12 comprises three cover housings 127 (only one housing is represented in FIG. 6) to accommodate each of the third compression springs 121. Each cover housing 127 faces the second circumferential surface 133 of the plate 13. The cover housings 127 ensure positioning of the third compression springs 121. The third compression springs 121 cannot therefore move radially with respect to the axis B.

The plate 13 is translationally movable between two positions:
A first position such that the plate 13 bears against the removable filter 18 (represented in FIGS. 7, 8 and 12) and the indicator pin 16 is in the retracted position;
A second position such that the plate 13 is remote from the removable filter 18 (represented in FIGS. 5, 6 and 11) and the indicator pin 16 is in the extended position.

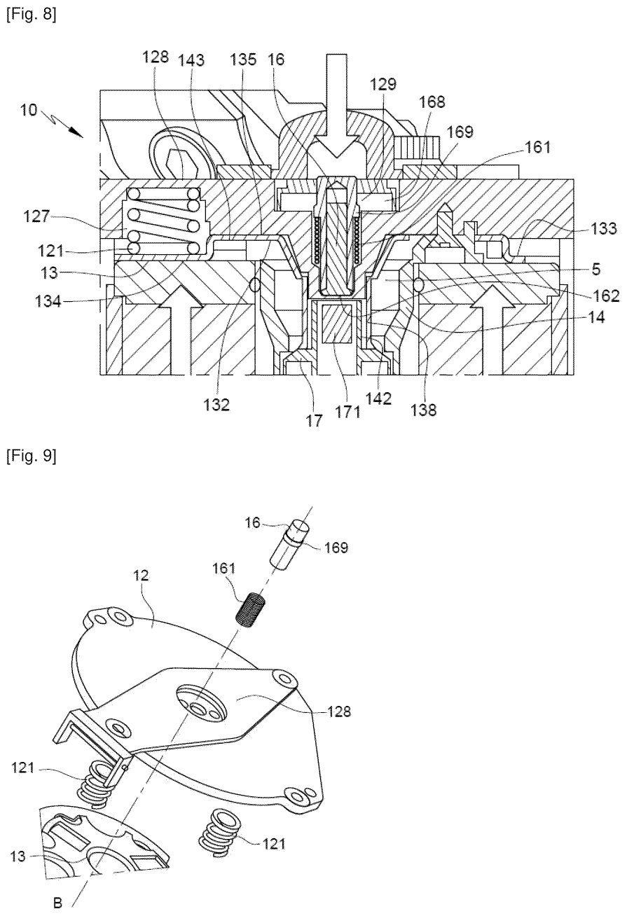

FIGS. 7 and 8 represent the device 10 when the plate 13 is in the first position. The removable filter 18 is in contact with a second planar surface 134 (visible in FIG. 8) of the cover 13. The removable filter 18 exerts pressure (illustrated by the two arrows positioned on the filter) on the second planar surface 134 compressing the third compression springs 121. The second planar surface 134 is parallel to the second circumferential surface 133 of the plate 13. In the first position, a third planar surface 135 of the plate 13 is on the stop on the cover 12 which thus blocks position of the plate 13.

The filter support 14 cooperates with the removable filter 18 through the first hollow cylinder 149 inserted in a hollow cylindrical shaped part 189 of the removable filter 18.

The device 10 comprises a cylindrical cup 3 inserted in the hollow part 189. The cup 3 is in cylinder-cylinder contact with the removable filter 18. The removable filter 18 is held in position via the cup 3. One end of the first hollow cylinder 149 is in cylinder-cylinder contact with the cup 3. For example, the cup 3 is screwed onto the filter support 14.

The removable filter 18 and the cup 3 are contained in a cylindrical shaped tank 4. The filter support 14 is in cylinder-cylinder contact with the tank 4. The cover is in cylinder-cylinder contact with the tank 4.

In the first position, the clogging valve 17 is in contact with the indicator pin 16. Thus, the magnet 171 exerts an electromagnetic force on the magnetic surface 162 of the indicator pin 16 such that the magnetic surface 162 is in contact with the magnet 171. In this first position, the indicator pin 16 is in the retracted position such that it does not project from the surface of the cover 128.

In the presence of the removable filter 18, when shifting from the second position to the first position, the clogging valve 17 translates along the axis B towards the indicator pin 16 via the first compression spring 141 which has a first compression force F1. Thus, the device 10 enables presence of the removable filter 18 to be detected by the presence of a visual indicator which is the indicator pin 16.

In the absence of the removable filter 18, when shifting from the first position to the second position, the clogging valve 17 translates in a direction opposite to the indicator pin 16 under the effect of the third compression force F3 of the third compression springs 121. The magnet 171 then moves away from the magnetic surface 162 so that the distance between the magnet 171 and the magnetic surface 162 is too great to allow the magnet 171 to hold the indicator pin in the retracted position. The second compression force F2 of the second compression spring 161 will then push the indicator pin 16 away from the clogging valve 17. The indicator pin 16 will then be in the extended position revealing absence of the removable filter 18 in the device 10.

The device 10 can be mounted in an oil or fuel circuit of a turbomachine. The device 10 also has a clogging detection function for the removable filter 18. If the removable filter 18 is clogged, the pressure in the device 10 increases upon putting the turbomachine into service created by a fluid, for example oil or fuel, circulating in the device. As represented in FIG. 7, as the fluid cannot be discharged by passing through the removable filter 18, the fluid will thereby concentrate in zone 5 of the filter support 14 and create pressure on the clogging valve 17, causing the clogging valve 17 to translate along axis B in the opposite direction to the indicator pin 16. At this point, the magnet 171 is no longer positioned inside the second hollow cylinder 138 of the plate 13. When the distance between the magnet 171 and the magnetic surface 162 is sufficiently large as a result of the translation of the clogging valve 17, then the magnet 171 no longer exerts a magnetic force on the magnetic surface 162, thus releasing the indicator pin 16 in the extended position as a result of the second compression force F2. Thus, the indicator pin 16 is in the extended position if the removable filter 18 is absent from the device 10 or if the removable filter 18 is clogged. This function for detecting clogging of the removable filter 18 is only possible upon putting the turbomachine into service.

Thus, the device 10 according to the invention makes it possible to add to the function for detecting clogging of the removable filter 18 already present in prior art, a function for detecting the removable filter 18 before the turbomachine according to the invention is put into service. This invention avoids making significant and costly modifications to the device of prior art to add the detection function for the removable filter 18.

With reference to FIG. 10, the clogging valve 17 comprises at its centre a bore 172 accommodating the first compression spring 141.

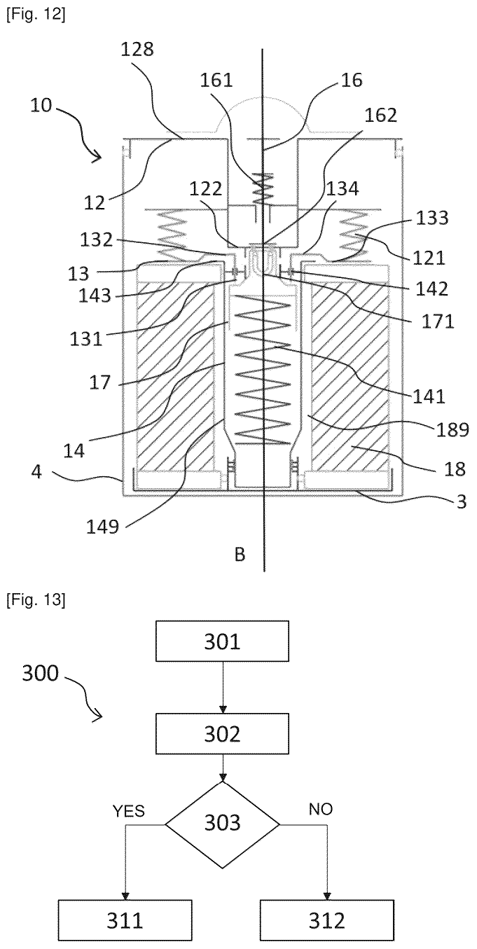

FIG. 12 is a functional representation of the filtering device 10 in the first position with the removable filter 18 mounted to the filter support 14.

A method 300, illustrated in FIG. 13, for indicating presence of the removable filter 18 in the device 10 comprises:
a step 301 of mounting the cover 12 to the device 10;
a step 302 of pressing on the indicator pin 16 translating the indicator pin 16 from the extended position to the retracted position; for example, the indicator pin 16 can be pressed on the part projecting from the surface of the cover 128 by an operator.
if, 303, the removable filter 18 is mounted to the device 10, then the indicator pin 16 is held in the retracted position 311. The magnetic surface 162 of the indicator pin 16 is in contact with the magnet 171 of the clogging valve 17. The magnet 171 holds the indicator pin 16 in the retracted position, thus revealing presence of the removable filter 18 in the device 10;
if, 303, the removable filter 18 is absent from the device 10, then the indicator pin 16 translates from the retracted position to the extended position 312. The magnetic surface 162 is not in contact with the magnet 171 in the absence of the removable filter 18 because the plate 13 is in the second position. The indicator pin 16 is not held in the retracted position. The indicator pin 16 via the second compression force F2 of the second compression spring 161 will then return to the extended position thus revealing absence of the removable filter 18 in the device 10.

After the mounting step 301, the indicator pin 16 is necessarily in the extended position due to the second compression force F2 of the second compression spring 161.

Thus, the indication method 300 makes it possible to easily and quickly detect presence of the removable filter 18 in the device 10 before the turbomachine is put into service by simply pressing on the indicator pin 16 when the latter is in the extended position. If after the pressure step 302, the indicator pin 16 does not move back up to the extended position, then the removable filter 18 is present in the device 10. Otherwise, the removable filter 18 is absent from the device 10.

1. A filtering device for a turbomachine comprising:
a. a filter support;
b. a removable filter cooperating with the filter support;
c. a cover translationally movable relative to the filter support;
d. a clogging valve translationally movable relative to the filter support and connected to one end of the filter support via a first compression spring with a first compression force;
e. a magnet positioned at one end of the clogging valve;
f. an indicator pin having a magnetic surface, being translationally movable relative to the cover and connected to the cover via a second compression spring with a second compression force, the magnetic surface facing the magnet, the indicator pin being translationally movable between two positions:
i. an extended position such that the indicator pin projects from a surface of the cover;
ii. a retracted position such that the indicator pin is in contact with the magnet;
the device comprises a plate integral with the clogging valve, the plate being translationally movable relative to the cover and relative to the indicator pin via third compression springs positioned between the plate and the cover, the third compression springs having a third compression force greater than the first compression force of the first compression spring, the plate being translationally movable between two positions:
g. a first position such that the plate bears against the removable filter and the indicator pin is in the retracted position;
h. a second position such that the plate is remote from the cover due to the absence of the removable filter and the indicator pin is in the extended position.

2. The device according to claim 1, wherein the plate comprises a first cylindrical surface cooperating with a second cylindrical surface of the filter support.

3. The device according to claim 1, wherein the plate comprises a first planar surface in contact with a first circumferential surface of the filter support when the plate is in the second position.

4. The device according to claim 1, wherein the third compression springs are each in contact with the cover and with a second circumferential surface of the plate.

5. The device according to claim 1, wherein the third compression springs are positioned in cover housings located in the cover.

6. A method for indicating presence of a filter in a device according to claim 1, the method comprising:
i. mounting the cover;
j. pressing on the indicator pin, translating the indicator pin from the extended position to the retracted position;
k. if the removable filter is mounted to the device, then the indicator pin is held in the retracted position;
l. if the removable filter is absent from the device, then the indicator pin translates from the retracted position to the extended position.

7. A turbomachine including a filtering device according to claim 1.
